(19) United States
(12) Patent Application Publication
(10) Pub. No.: US 2002/0198948 A1
(43) Pub. Date: Dec. 26, 2002

(54) Virtual email server system

(75) Inventor: Yung-Chih Lin, Taipei Hsien (TW)

Correspondence Address: Richard P. Berg, Esq., c/o LADAS & PARRY, Suite 2100, 5670 Wilshire Boulevard, Los Angeles, CA, 90036-5679, US

(73) Assignee: Acer Inc.

(21) Appl. No.: 09/997,138

(22) Filed: Nov. 28, 2001

(30) Foreign Application Priority Data
Jun. 26, 2001 (TW) 90115411

(51) Int. Cl. G06F 15/16

(52) U.S. Cl. 709/206; 709/246

(57) ABSTRACT

A virtual email server system for providing at least one PDA to receive email from an incoming message server. The virtual email server system includes a database, pre-process agent, mail agent, and content converter agent. After a predetermined time interval, the mail agent outputs a signal to the pre-process agent to query identity information for the last message Then, the mail agent checks the incoming message server according to the identity information and receives a new message from the incoming message server. Thereafter, the mail agent forwards the new message to the content converter agent to transform content of the new message into an internally formatted message. Finally, the content converter agent sends the internally formatted message to the pre-process agent, and the pre-process agent stores the internally formatted message to the database.

### BACKGROUND OF THE INVENTION

1. Field of the Invention

The present invention relates to a virtual email server system, and particularly to a virtual email server system providing online receiving and sending of email by PDAs (Personal Digital Assistants) through wireless networks in real time.

2. Description of the Related Art

In recent years, with the popularization of mobile communication devices, such as PDAs (Personal Digital Assistants) and cellular phones, system providers of mobile communication service are increasingly called upon to provide enhanced email service by these devices.

However, in existing systems, mobile communication devices have to synchronize with a computer through a cable or IR (infrared) to receive or send email. Due to inherent limits, the device's online email capability is limited in terms of location and time, nor can users directly view attachments.

Because of these limitations, the value of mobile communication, including convenience, speed, and effectiveness, is significantly reduced.

FIG. 1 is a schematic diagram showing a conventional method of receiving and sending email by a PDA. For PDA 100 to receive or send email, it must connect with a computer 200 by cable or IR. The PDA 100 may then access a message application (not shown in FIG. 1) provided by computer 200 to receive email from an incoming message server 300, or to send email to an outgoing message server 400.

As described above, in existing systems, email operation takes place in an offline mode, thus failing to satisfy the requirements of real-time information in the mobile environment. In addition, the variety of data encoding types restricts mobile communication devices from opening all email contents and/or attachments, users may miss important information.

### SUMMARY OF THE INVENTION

It is therefore an object of the present invention to provide a virtual email server system providing online receiving and sending of email by PDAs through wireless networks in real time. Another object of the present invention is to provide a virtual email server system having the capability to transform email contents and/or attachments into a format recognizable by the mobile communication devices.

To achieve the above objects, the present invention provides a virtual email server system providing at least one PDA to receive/send email from/to at least one incoming message server/outgoing message server. The virtual email server system includes a database, pre-process agent, mail agent, and content converter agent.

After a predetermined time interval, the mail agent outputs a signal to the pre-process agent to query identity information for the last message in the database coupled to the pre-process agent. Then, the mail agent checks the incoming message server according to the identity information and receives a new message received after the last message from the incoming message server.

Thereafter, the mail agent forwards the new message to the content converter agent to transforming content of the new message into an internally formatted message recognizable by the PDA. Finally, the content converter agent sends the internally formatted message to the pre-process agent, and the pre-process agent stores the internally formatted message to the database.

For the PDA to receive messages, the PDA sends a message receiving signal to the pre-process agent through a wireless network and downloads the internally formatted message in the database according to the message receiving signal. On the other hand, for the PDA to send messages, the PDA sends a new edited message to the mail agent through the wireless network and then the mail agent sends the new edited message to the outgoing message server.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram showing a conventional method of receiving and sending email by a PDA; and

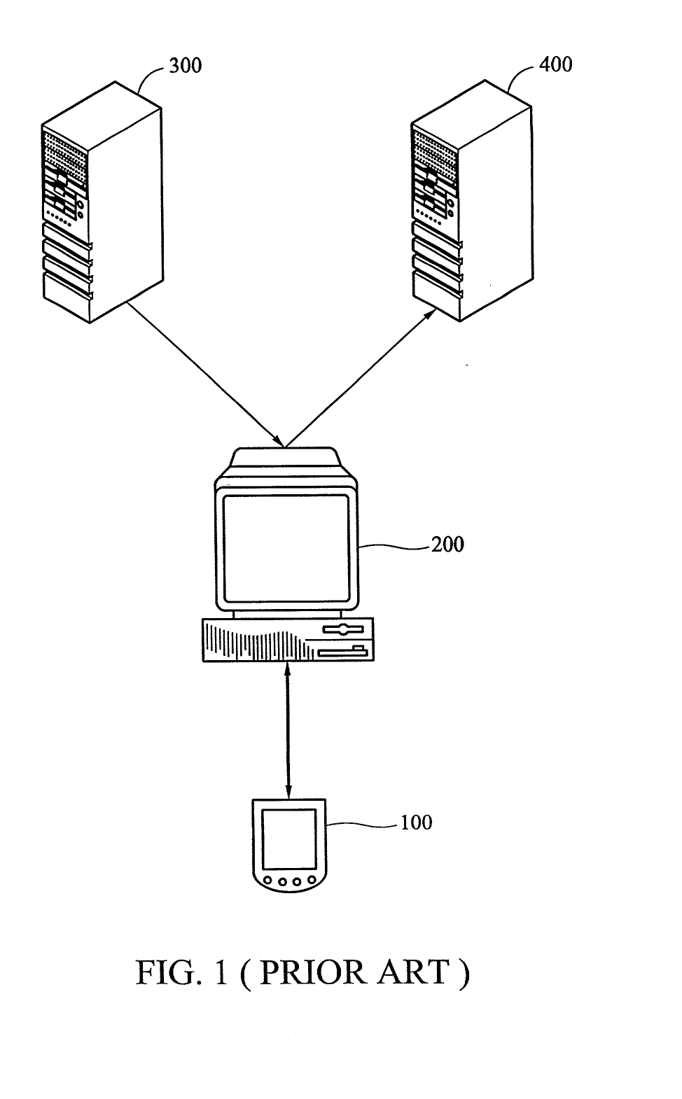

FIG. 2 is a schematic diagram showing the system structure of a virtual email server system according to the embodiment of the present invention.

### DETAILED DESCRIPTION OF THE PREFERRED EMBODIMENT

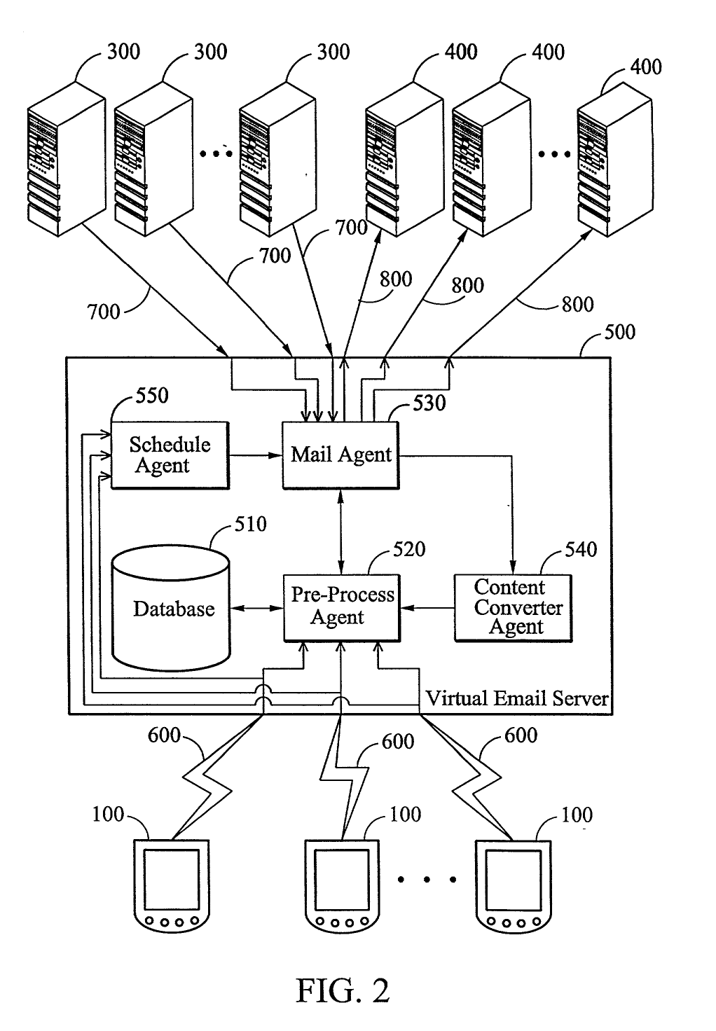

Next, FIG. 2 shows the system structure of a virtual email server system according to the embodiment of the present invention. Referring to FIG. 2, a preferred embodiment according to the present invention will be described in detail as follows.

As shown in FIG. 2, a virtual email server system according to the embodiment of the present invention may provide a plurality of PDAs 100 to exchange data with a virtual server 500 through a wireless network 600. The virtual server 500 may couple with a plurality of incoming message servers 300, such as POP3 servers, to receive messages through a network 700, and the virtual server 500 may couple with a plurality of outgoing message servers 400, such as SMTP servers, to send messages through a network 800.

The virtual server 500 includes a database 510, pre-process agent 520, mail agent 530, content converter agent 540, and schedule agent 550. The database 510 stores the messages belong to each of the PDAs 100, and the pre-process agent 520 is responsible to access the database 510.

The mail agent 530 is responsible for receiving messages from these incoming message servers 300 and sending messages to these outgoing message servers 400. The content converter agent 540 transforms the messages received by the mail agent 530 into an internally formatted message recognizable by the PDAs.

The schedule agent 550 can set a schedule to automatically receive and/or send messages. When the schedule is implemented, the schedule agent 550 sends a startup signal to the mail agent 530 to start the process of receiving messages. The schedule in the schedule agent 550 can be set by a computer (not shown) coupled with the virtual server 500 through the Internet. In addition, the PDAs can also log into the virtual server 500 through the wireless network 600, and connect with the schedule agent 550 to set the schedule.

The operation of the virtual email server system is described as follows. It should be noted that the description below is discussed only using a PDA 100, an incoming message server 300, and an outgoing message server 400. However, the present invention is suitable for a plurality of PDAs 100, incoming message servers 300, and outgoing message servers 400.

Process of Automatically Receiving Messages

There are two ways in which the system automatically receives messages. In the first case, the schedule has been set in the schedule agent 550. For example, the schedule is set to 10 AM and 3 PM. When the schedule is implemented, the schedule agent 550 sends a startup signal to the mail agent 530, and the mail agent 530 starts the process of receiving messages according to the signal. In the other case, the mail agent 530 automatically receives messages at predetermined time intervals.

It should be noted that the predetermined time interval can also be set by a computer (not shown) coupled with the virtual server 500 through the Internet. In addition, the PDAs can also log into the virtual server 500 through the wireless network 600, and set the predetermined time interval.

In both cases, when the process of receiving messages is started, the mail agent 530 outputs a query signal to the pre-process agent 520. The pre-process agent 520 queries identity information for the last message in the database 510 coupled to the pre-process agent 520 according to the query signal, and sends the identity information back to the mail agent 530. It should be noted that the query process avoids duplicate messages in the following process.

The mail agent 530 then checks an incoming message server 300 assigned by a PDA 100 according to the identity information through the network 700. If there is at least one new message received after the last message in the incoming message server 300, the mail agent 530 receives the new message from the incoming message server 300. Note that each of the PDAs 100 can set several incoming message servers 300 in the virtual email server system.

Thereafter, the mail agent 530 forwards the new message to the content converter agent 540. The content converter agent 540 then transforms content of the new message into an internally formatted message recognizable by the PDA 100. It should be noted that the content converter agent 540 can transform the content of the new message from one encoding type to another, or perform the appropriate process on attached files, such that the entire new message including attached files can be displayed in the PDA 100 directly, without losing any information.

Finally, the content converter agent 540 sends the internally formatted message to the pre-process agent 520, and the pre-process agent 520 stores the internally formatted message to the database 510.

Operation of PDA Receiving Messages

For the PDA 100 to receive messages, the PDA 100 sends a message receiving signal to the virtual server 500 through the wireless network 600. After the virtual server 500 performs identification procedures on the message receiving signal, the virtual server 500 forwards the message receiving signal to the pre-process agent 520.

For the pre-process agent 520 receives the message receiving signal, the pre-process agent 520 retrieves the internally formatted message belong to the PDA 100 in the database 510 according to the message receiving signal. Finally, the pre-process agent 520 sends the internally formatted message to the PDA 100 through the wireless network 600.

Operation of PDA Sending Messages

For the PDA 100 to send messages, the PDA 100 sends a new edited message to the virtual server 500 through the wireless network 600. Similarly, after the virtual server 500 performs identification procedures, the virtual server 500 forwards the new edited message to the mail agent 530.

For the mail agent 530 receives the new edited message, the mail agent 530 determines whether the outgoing message server 400 assigned by the PDA has a failure. In this case, each of the PDAs 100 can set several outgoing message servers 400 in the virtual email server system, and if one of the outgoing message servers 400 has a failure, the mail agent 530 determines whether another outgoing message server 400 has a failure. The mail agent 530 then sends the new edited message to a well functioned outgoing message server 400.

As a result, the virtual email server system of the present invention provides online receiving and sending of email by PDAs through wireless networks in real time. Furthermore, with the capability to transform the email contents and/or attachments into a format recognizable by the mobile communication devices, the entire message, including any attached files, can be displayed in the PDAs directly, without losing any information.

Further, the present invention provides the following advantages.

First, the virtual server is a platform for several PDAs to receive and/or send email at same time, and it also provides PDAs to set several incoming message servers and outgoing message servers for more flexible use.

Second, the virtual email server system according to the present invention is an online system, and the PDA can receive and send online email anytime and anywhere, increasing the value of mobile communication.

Third, the automatically received messages can be transformed and stored to the database of the virtual server, thus reducing time required to download messages to the PDA.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A virtual email server system to allow at least one PDA to receive email from an incoming message server, comprising:
a database;
a pre-process agent for receive a signal to query identity information for the last message in the database and output the identity information, receiving an internally formatted message and storing the internally formatted message to the database, and fetching the internally formatted message from the database and sending the internally formatted message to the PDA through network when receiving a message receiving signal from the PDA;
a mail agent for outputting the query signal, receiving the identity information and checking the incoming message server according to the identity information, and receiving a new message received after the last message from the incoming message server and forwarding the new message; and
a content converter agent for receiving the new message forwarded from the mail agent, transforming the new message into the internally formatted message, and outputting the internally formatted message.

2. The system as claimed in claim 1 further comprising a schedule agent for setting a schedule and outputting a startup signal when the schedule is implemented.

3. The system as claimed in claim 2 wherein the mail agent further receives the startup signal and outputs the query signal based thereon.

4. The system as claimed in claim 2 wherein the schedule can be set by a computer coupled with the schedule agent through the Internet.

5. The system as claimed in claim 2 wherein the schedule can be set by the PDA coupled with the schedule agent through a wireless network.

6. The system as claimed in claim 1 wherein the mail agent outputs the query signal after a predetermined time interval.

7. The system as claimed in claim 6 wherein the predetermined time interval can be set by a computer through the Internet.

8. The system as claimed in claim 6 wherein the predetermined time interval can be set by the PDA through a wireless network.

9. The system as claimed in claim 1, wherein the internally formatted message has a format recognized by the PDA.

10. The system as claimed in claim 1 further comprising an outgoing message server coupled with the mail agent.

11. The system as claimed in claim 10 wherein the PDA sends a new edited message to the mail agent through a wireless network and then the mail agent sends the new edited message to the outgoing message server.

12. An email server system, comprising:
an outgoing message server;
an incoming message server; and
a virtual server, comprising:
a database;
a pre-process agent to receive a signal querying identity information for the last message in the database and output the identity information, receive an internally formatted message and store the internally formatted message to the database, fetch the internally formatted message from the database and output the internally formatted message when receiving a message receiving signal;
a mail agent for outputting the query signal after a predetermined time interval, receiving the identity information and checking and receiving at least one new message in the incoming message server according to the identity information, forwarding the new message, and receiving a new edited message and sending the new edited message to the outgoing message server;
a content converter agent for receiving the new message forwarded from the mail agent, transforming the new message into the internally formatted message, and outputting the internally formatted message; and
a PDA coupled to the virtual server through a wireless network to output the message receiving signal, receive the internally formatted message, and send the new edited message.

13. The system as claimed in claim 12 wherein the virtual server further comprises a schedule agent for setting a schedule, and outputting a startup signal when the schedule is implemented.

14. The system as claimed in claim 13 wherein the mail agent further receives the startup signal and outputs the query signal based thereon.

15. The system as claimed in claim 13 wherein the schedule can be set by a computer coupled with the schedule agent through the Internet.

16. The system as claimed in claim 13 wherein the schedule can be set by the PDA coupled with the schedule agent through a wireless network.

17. The system as claimed in claim 12 wherein the predetermined time interval can be set by a computer through the Internet.

18. The system as claimed in claim 12 wherein the predetermined time interval can be set by the PDA through a wireless network.

19. The system as claimed in claim 12 wherein the internally formatted message has a format recognized by the PDA.
